(19) United States
(12) Patent Application Publication
(10) Pub. No.: US 2016/0371467 A1
(43) Pub. Date: Dec. 22, 2016

(54) QUANTITATIVE COMPARATIVE ANALYSIS METHOD FOR MOLECULAR ORBITAL DISTRIBUTION, AND SYSTEM USING SAME

(71) Applicant: LG CHEM, LTD., Seoul (KR)

(72) Inventors: Seungyup LEE, Daejeon (KR); Hyesung CHO, Daejeon (KR); Jongchan KIM, Daejeon (KR)

(21) Appl. No.: 14/901,568

(22) PCT Filed: Jul. 16, 2014
(86) PCT No.: PCT/KR2014/006425

§ 371 Date: Dec. 28, 2015

(30) Foreign Application Priority Data
Jul. 18, 2013 (KR) 10-2013-0084619

(51) Int. Cl. G06F 19/00; G06F 17/11

(52) U.S. Cl. CPC G06F 19/701; G06F 17/11

(57) ABSTRACT

Disclosed herein are a method for quantitatively analyzing a molecular orbital distribution, and a quantitative analysis system of molecular orbital distributions using the same. The method comprise a) selecting two molecular orbitals to be compared for molecular orbital distributions and computing molecular orbital distributions by quantum chemistry calculation; b) calculating structural properties of each molecular orbital by means of an RDM (radially discrete mesh) calculation method, followed by matching with the molecular orbital distributions computed in step a) to obtain molecular orbital distributions according to the structural properties; and c) comparing the two molecular orbital distributions according to structural properties, obtained by RDM in step b), using a profiling method.

### TECHNICAL FIELD

The present invention relates to a method for quantitatively analyzing a molecular orbital distribution, and a system using the same. More particularly, the present invention relates to a novel analysis method by with molecular orbital distributions are quantitatively compared, and a system using the same.

### BACKGROUND ART

Because intrinsic electrochemical properties of materials are greatly influenced by electron transfer and distribution therein, it is very important to simulate the behavior of an electron in a molecule in developing a material. The behavior of an electron is expressed as the probability of finding an electron in any specific region. A molecular orbital is introduced as a concept to simulate the behavior of an electron. A molecular orbital, which accounts for the distribution of an electron in a specific region in a molecular structure as a probability concept, cannot be obtained experimentally, but can be constructed by the Schrödinger equation using quantum mechanics.

The molecular orbital distribution that has been quantum-mechanically computed thus far is regarded as a qualitative measurement in which 3- or 2-dimensional diagrams created through a contour plot are used for visual comparison, for example, as described in “Analysis of Electron Delocalization in Aromatic Systems: Individual Molecular Orbital Contributions to Para-Delocalization Indexes (PDI)”. FIG. 1 is a diagram showing the molecular orbital distribution of NPB (N,N′-Di[(1-naphthyl)-N,N′-diphenyl]-1,1′-(biphenyl)-4,4′-diamine), which is used in an OLED film, in terms of Neutral/HOMO. To depict FIG. 1, Materials Visualizer of the program Materials Studio for simulating and modeling molecular orbitals was used. In the diagram, the molecular orbital distribution is expressed as a region in which an electron is likely to exist (yellow/green regions). FIG. 1 shows a generally even molecular orbital distribution over the entire molecule.

As is perceived in this case, however, the qualitative measurement through visualization does not provide an accurate criterion of analysis, so that even the same molecular orbital distribution may be analyzed differently. For FIG. 1, by way of example, there may be different estimation results: (1) the molecular orbital is highly evenly distributed because the molecular orbital is distributed over the entire molecule, or (2) the molecular orbital is fairly distributed because the distribution is poor in opposite ends of the naphthalene moieties. The problem with this qualitative measurement is more evident when two molecular orbital distributions, rather than one molecule, are compared to each other. In many materials development cases, electrochemical properties are estimated by comparing the distribution of molecular orbital A with that of molecular orbital B. Since the qualitative comparison through visualization may result in greatly different estimation data depending on the criterion, estimation of two or more molecular orbital distributions is more prone to being inaccurate than that of one molecular orbital distribution. This problem not only arises upon the comparison of orbital distributions, but is one of the most fundamental limitations for all qualitative approaches. Given an effective, accurate and reliable measurement approach to the molecular orbital distribution, which has been estimated only qualitatively thus far, materials development can be more effectively achieved with reference to properties determined by the molecular orbital distribution as well as the fundamental properties determined by electron transfer, such as electron affinity.

In this regard, Japanese Patent Application Unexamined Publication No. 2011-173821 discloses a novel method for predicting the activity of a new chemical material using an index of reactivity of a molecule, computed on the basis of quantum chemistry calculation in consideration of a reactive molecular orbital as well as a frontier orbital. However, this conventional method is limitedly applied to the quantitative comparison of molecular orbital distributions between two molecules.

### DISCLOSURE

### Technical Problem

Accordingly, the present invention has been made keeping in mind the above problems occurring in the prior art, and an object of the present invention is to provide MOD-Dscore (Molecular Orbital Distribution-Deviation Score), which allows for the analysis of molecular orbital distribution deviation between compounds in a quantitative manner (score), whereby molecular orbital distributions calculated on the basis of quantum chemistry can be compared in a systemic, quantitative process, thus finding applications in developing novel materials.

### Technical Solution

In order to accomplish the above object, the present invention provides a method for quantitatively analyzing a molecular orbital distribution, comprising:

a) selecting two molecular orbitals to be compared for molecular orbital distributions and computing molecular orbital distributions by quantum chemistry calculation,
b) calculating structural properties of each molecular orbital by means of an RDM (radially discrete mesh) calculation method, followed by matching with the molecular orbital distributions computed in step a) to obtain molecular orbital distributions according to the structural properties, and
c) comparing the two molecular orbital distributions according to structural properties, obtained by RDM in step b), using a profiling method.

Also, the present invention provides a system for quantitatively analyzing a molecular orbital distribution, comprising:

a data input module in which two molecular orbitals to be compared for molecular orbital distributions are selected, and computed for molecular orbital distributions by quantum chemistry calculation, and the data on molecular orbital distributions are input;
a molecular structure determining module in which structural properties of each molecular orbital are calculated by means of an RDM (radially discrete mesh) calculation method, and then matched with the molecular orbital distributions input into the data input module to obtain molecular orbital distributions according to the structural properties; and
a comparison module in which the two molecular orbital distributions according to structural properties, obtained by RDM in the molecular structure determining module, are compared using a profiling method.

### Advantageous Effects

As described above, the quantitative analysis method of molecular orbital distributions in accordance with the present invention allows for the analysis of molecular orbital distribution deviation between compounds in a quantitative manner (score) in a profiling process using MOD-Dscore (Molecular Orbital Distribution-Deviation Score), whereby molecular orbital distributions calculated on the basis of quantum chemistry can be compared in a systemic, quantitative process, thus finding applications in developing novel materials.

### DESCRIPTION OF DRAWINGS

FIG. 1 is a diagram of the structure and molecular orbital distribution of NPB.

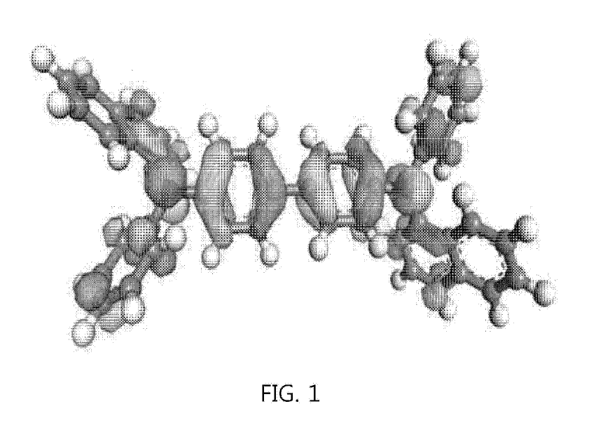

FIG. 2 is a schematic view illustrating RDM calculation.

FIG. 3 is a diagram illustrating molecular orbital distributions of NPB in anion/neutral/cation states, respectively, as compared in Examples 1 and 2.

### BEST MODE

Below, a detailed description will be given of the present invention.

In accordance with an aspect thereof, the present invention addresses a method for quantitatively analyzing a molecular orbital distribution, comprising: a) selecting two molecular orbitals to be compared for molecular orbital distributions and computing molecular orbital distributions by quantum chemistry calculation, b) calculating structural properties of each molecular orbital by means of an RDM (radially discrete mesh) calculation method, followed by matching with the molecular orbital distributions computed in step a) to obtain molecular orbital distributions according to the structural properties, and c) comparing the two molecular orbital distributions according to structural properties, obtained by RDM in step b), using a profiling method.

Herein, the quantitative analysis method of molecular orbital distributions is termed “MOD-Dscore (Molecular Orbital Distribution-Deviation Score) method”. The “MOD-Dscore method” allows for systemic, quantitative comparison of molecular orbital distributions computed on the basis of quantum chemistry. Hereinafter, the MOD-Dscore method will be elucidated in detail.

In step a) of the method of the present invention, two molecular orbitals to be compared for molecular orbital distributions are selected, and the molecular orbital distributions are calculated using quantum chemistry calculation. A molecular orbital is defined as a mathematical function describing the wave-like behavior of an electron in a molecule. In the present invention, the two molecular orbitals to be compared for molecular orbital distribution may be two electron states of one molecule (for example, Neutral/HOMO and Neutral/LUMO for the same molecule), or the same or different electron states for two different molecules (for example, Neutral/HOMO of molecule A and Neutral/HOMO of molecule B, or Neutral/HOMO of molecule A and Anion/LUMO of molecule B). After two molecular orbitals for comparison of molecular orbital distributions are selected, quantum chemistry calculation for each molecular orbital is performed to give a molecular orbital distribution. Any calculation method that takes advantage of quantum chemistry may be employed to obtain molecular orbital distributions, without limitations. Preferable may be calculation through the distribution of the electron density function (ψ2), which is a square of the orbital wave function (ψ), in each point determined in a molecular structure, or single point energy or geometry optimization calculation. In detail, the present inventors calculate molecular orbital distributions using the program MATERIALS STUDIO DMol3 (ACCELRYS) that uses the density functional theory (DFT).

Next, the MOD-Dscore method goes with b) calculating structural properties of each molecular orbital by means of an RDM (radially discrete mesh) calculation method, followed by matching with the molecular orbital distributions computed in step a) to obtain molecular orbital distributions according to the structural properties.

The calculation of structural properties can be carried out using atomic coordinates of (x, y, z). This information should be combined with the molecular orbital distributions calculated according to the structural properties. The reason why the calculation of structural properties is needed is that the information of coordinates of molecular structures is just data spread over the molecule, which cannot provide any other valuable information. In the present invention, hence, the calculation of structural properties of a given molecule can be accomplished by creating an RDM (radially discrete mesh) starting from the center of the molecule, and then designating regions corresponding to RDMs to compute an RDM accounting for the entire molecular structure. This RDM represents meshes expanding at regular intervals in a radial direction from the center of the molecule. In calculating molecular structures by means of RDM, the intramolecular center (xc, yc, zc) is obtained as illustrated by the following Equations 1-1 to 1-3:

$$\begin{matrix}{X}_{C} = \frac{1}{{N}^{AT}} {\sum }_{k = 1}^{{N}^{AT}} {X}_{k} & ( Equation 1 \text{-} 1 ) \\ {Y}_{C} = \frac{1}{{N}^{AT}} {\sum }_{k = 1}^{{N}^{AT}} {Y}_{k} & ( Equation 1 \text{-} 2 ) \\ {Z}_{C} = \frac{1}{{N}^{AT}} {\sum }_{k = 1}^{{N}^{AT}} {Z}_{k} & ( Equation 1 \text{-} 3 )\end{matrix}$$

wherein NAT represents a total number of atomic coordinates constituting the molecule.

Using the RDM method described above, the molecular structure is subdivided, and the subdivided regions are matched with molecular orbital distributions.

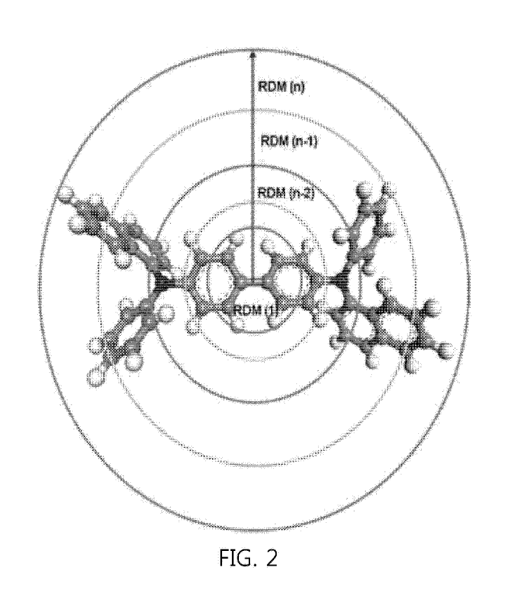

RDM calculation can be further illustrated referring to FIG. 2. RDM is increased like RDM (1), RDM (2), . . . , and RDM (n) until all the atoms of the molecular structure are included. Here, RDM(1) is the most proximal to the center of the molecule while RDM(n) is the outermost RDM including the entire molecule therein. In the RDM calculation, n, the total number of RDMs, is set to be the same for the two molecular orbitals to be compared with each other. No special limitations are imparted to the n values; however, n preferably ranges from 50 to 300, and more preferably from 100 to 300. Molecular orbital distributions are calculated for each of the calculated RDMs. The molecular orbital information calculated with regard to the molecular structure is matched with information on structural properties converted into a total of n RDMs. The RDM information thus obtained is used for calculating a graph-based profile in step c) as described later.

Subsequently, Next, the MOD-Dscore method according to the present invention proceeds with c) comparing in a profile process the molecular orbital distributions according to structural properties obtained through the two RDMs in step b).

In the present invention, calculation of the two RDMs in step b) can be used to account for the distribution of molecular orbitals with regard to each RDM. This is a termed RDM-profile. In the present invention, a graph-based profile is created for the molecular orbital distributions matched through the RDM structure characterization of the two molecular orbitals, and used to calculate a profile deviation in the molecular orbital distribution of the graph. That is, a deviation of molecular orbital distribution in each RDM, with regard to the entire structure is calculated. The profile deviation in one RDM ranges from 0 to 1.0. When the profile deviation is 0 (zero), the two profiles are identical. A greater profile deviation means that the two profiles are more different. As such, profile comparison can indicate quantitative deviation of the molecular orbital distributions that are matched with regard to structures according to two molecular orbitals via each RDM. This can further embodied by obtaining the TPD (total profile deviation) of Equation 2, which represents the sum of all the RDMs:

$$TPD = \frac{1}{N} {\sum }_{k = 1}^{N} \vert Prof ( {A}_{k} ) - Prof ( {B}_{k} ) \vert \qquad ( Equation 2 )$$

(wherein Prof(Ak) and Prof(Bk) are molecular orbital values of respective RDM (k), and N is a total number of RDMs.)

Using the TPD value, MOD-Dscore by which a deviation between two molecular orbital distributions can be further quantitatively compared can be calculated according to the following Equation 3:

MOD-Dscore=1.0−TPD (Equation 3)

Calculated values of MOD-Dscore are between 0.0 and 1.0. When two molecular orbital distributions are accurately identical, TPD has a value of 0.0, and thus MOD-Dscore is 1.0. Greater deviation between two molecular orbital distributions makes MOD-Dscore smaller than 1.0. As such, distribution deviation between two molecular orbitals can be quantitatively analyzed by MOD-Dscore.

In accordance with another aspect thereof, the present invention addresses a system for quantitatively analyzing a molecular orbital distribution, using the quantitative analysis method described above.

The quantitative analysis system of molecular orbital distributions comprises: a data input module in which two molecular orbitals to be compared for molecular orbital distributions are selected and computed for molecular orbital distributions by quantum chemistry calculation, and the data on molecular orbital distributions are input; a molecular structure determining module in which structural properties of each molecular orbital are calculated by means of an RDM (radially discrete mesh) calculation method, and then matched with the molecular orbital distributions input into the data input module to obtain molecular orbital distributions according to the structural properties; and a comparison module in which the two molecular orbital distributions according to structural properties, obtained by RDM in the molecular structure determining module, are compared using a profiling method.

In the quantitative analysis system of orbital distributions, the two molecular orbitals to be compared for molecular orbital distribution may be two electron states of one molecule (for example, Neutral/HOMO and Neutral/LUMO for the same molecule), or the same or different electron states for two different molecules (for example, Neutral/HOMO of molecule A and Neutral/HOMO of molecule B, or Neutral/HOMO of molecule A and Anion/LUMO of molecule B).

In the data input module, quantum chemistry calculation can be conducted through the distribution of the electron density function (ψ2), which is a square of the orbital wave function (ψ), in each point determined in a molecular structure, as described in the quantitative analysis method of molecular orbital distributions. Preferable may be single point energy or geometry optimization calculation.

In the molecular structure-determining module, the calculation of structural properties can be carried out using atomic coordinates of (x, y, z), as described in the quantitative analysis method of molecular orbital distributions, and may take advantage of the RDM (radially discrete mesh) calculation method.

As described in the quantitative analysis method of molecular orbital distributions, the RDM calculation is characterized in that molecular orbital distributions included within each RDM are matched to give RDM information.

A total number of RDMs used in the RDM (radially discrete mesh) calculation method may preferably range from 50 to 300, and more preferably from 100 to 250.

In the comparison module, the calculation of structural properties is performed using a profiling method, as described in the quantitative analysis method of molecular orbital distributions. This profiling method may take advantage of an RDM profile method by which comparison is made of molecular orbital distribution deviation in each RDM between two molecular orbitals.

The profiling method for structural property calculation in the comparison module may employ TPD (total profile deviation) as represented by the following Equation 2.

$$TPD = \frac{1}{N} {\sum }_{k = 1}^{N} \vert Prof ( {A}_{k} ) - Prof ( {B}_{k} ) \vert \qquad ( Equation 2 )$$

(wherein Prof(Ak) and Prof(Bk) are molecular orbital values of respective RDM (k), and N is a total number of RDMs.)

Further, the profiling method for structural property calculation in the comparison module may utilize MOD-Dscore as represented by the following Equation 3:

MOD-Dscore=1.0−TPD (Equation 3)

As used herein, the term “module” means a unit in which a certain function or action is processed, and may be embodied by hardware or software or a combination of hardware and software.

### MODE FOR INVENTION

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

### EXAMPLES

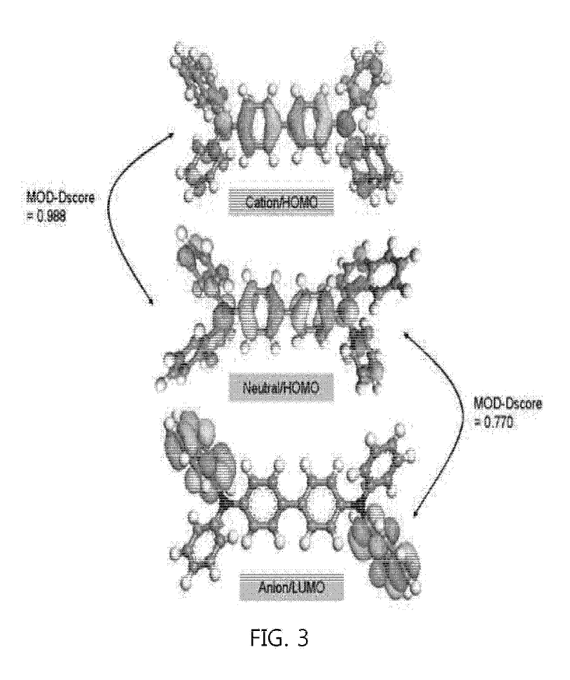

Quantitative comparison was made of molecular orbital distribution deviation between two molecular orbitals. In this regard, MOD-Dscore, developed in the present invention, was applied to the quantitative comparison of molecular orbital distribution deviations in an NPB molecule. First, three molecular orbitals of NPB were depicted in FIG. 3, using a visualization program. The diagrams were qualitatively estimated with the naked eye as follows.

(1) Cation/HOMO: even molecular orbital distribution over the entire molecule.
(2) Neutral/HOMO: even molecular orbital distribution over the entire molecule, as in Cation/HOMO.
(3) Anion/LUMO: localized molecular orbital distribution to the opposite end naphthalene moieties of the molecule, with no distributions of molecular orbitals in the other regions.

For comparison with the qualitative estimation, MOD-Dscore of the present invention was tested to quantitatively estimate deviation between two molecular orbital distributions. To this end, the Neutral/HOMO state of NPB was compared with the other two molecular orbital states using MOD-Dscore. For calculating molecular orbital distributions, MATERIALS STUDIO DMol3 (ACCELRYS) was employed wherein n for RDM calculation was set to be 200.

### Example 1

### Comparison of Molecular Orbital Deviation Between Neutral/HOMO and Anion/LUMO

Referring to FIG. 3, a molecular orbital distribution deviation between Neutral/HOMO and Anion/LUMO is qualitatively explained, indicating even molecular orbital distribution over the entire structure in Neutral/HOMO and localized molecular orbital distribution to opposite ends of the molecule in Anion/LUMO.

As a result of the quantitative estimation according to the present invention, a MOD-Dscore value of 0.770, much smaller than 1.0, indicates an even distribution of molecular orbitals for Neutral/HOMO, and extreme localization of molecular orbitals in the molecule for Anion/LUMO. Accordingly, the MOD-Dscore method of the present invention explained the molecular orbital distribution deviation between Neutral/HOMO and Anion/LUMO, accurately and numerically.

### Example 2

### Comparison of Molecular Orbital Deviation Between Neutral/HOMO and Cation/HOMO

Referring to FIG. 3, a molecular orbital distribution deviation between Neutral/HOMO and Anion/LUMO is qualitatively explained, indicating even molecular orbital distribution over the entire structure in both Neutral/HOMO and Cation/HOMO.

As a result of the quantitative estimation according to the present invention, a MOD-Dscore value of 0.988 is very close to 1.0. Accordingly, the MOD-Dscore method of the present invention explained the molecular orbital distribution deviation between Neutral/HOMO and Anion/LUMO, accurately and numerically, even when the molecular orbital distributions are almost the same.

1. A method for quantitatively analyzing a molecular orbital distribution, comprising:
a) selecting two molecular orbitals to be compared for molecular orbital distributions and computing molecular orbital distributions by quantum chemistry calculation;
b) calculating structural properties of each molecular orbital by means of an RDM (radially discrete mesh) calculation method, followed by matching with the molecular orbital distributions computed in step a) to obtain molecular orbital distributions according to the structural properties; and
c) comparing the two molecular orbital distributions according to structural properties, obtained by RDM in step b), using a profiling method.

2. The method of claim 1, wherein the two molecular orbitals are two electron states of one molecule, or identical or different electron states for two different molecules.

3. The method of claim 1, wherein the quantum chemistry calculation of step a) is conducted through the distribution of an electron density function (ψ2) in each point determined in a molecular structure, the electron density function being a square of an orbital wave function (ψ).

4. The method of claim 1, wherein the quantum chemistry calculation of step a) is conducted using single point energy calculation or geometry optimization calculation.

5. The method of claim 1, wherein the calculation of structural properties in step b) is carried out using atomic coordinates of (x, y, z).

6. The method of claim 1, wherein the RDM (radially discrete mesh) calculation method of step b) is carried out by creating meshes that are structured to expand at regular intervals in a radial direction, starting from a center of a molecule.

7. The method of claim 6, wherein the RDM (radially discrete mesh) calculation method of step b) employs a total number (N) of 50 to 300 of RDM.

8. The method of claim 1, wherein the profiling method of step c) utilize an RDM profile method by which comparison is made of molecular orbital distribution deviation in each RDM between two molecular orbitals.

9. The method of claim 1, wherein the profiling method of step c) employs TPD (total profile deviation) as represented by the following Equation 2:
$$TPD = \frac{1}{N} {\sum }_{k = 1}^{N} \vert Prof ( {A}_{k} ) - Prof ( {B}_{k} ) \vert \qquad ( Equation 2 )$$
(wherein Prof(Ak) and Prof(Bk) are molecular orbital values of respective RDM (k), and N is a total number of RDMs.)

10. The method of claim 9, wherein the profiling method of step c) utilizes MOD-Dscore as represented by the following Equation 3:
MOD-Dscore=1.0-TPD (Equation 3)

11. A system for quantitatively analyzing a molecular orbital distribution, comprising:
a) a data input module in which two molecular orbitals to be compared for molecular orbital distributions are selected and computed for molecular orbital distributions by quantum chemistry calculation, and the data on molecular orbital distributions are input;
b) a molecular structure determining module in which structural properties of each molecular orbital are calculated by means of an RDM (radially discrete mesh) calculation method, and then matched with the molecular orbital distributions input into the data input module to obtain molecular orbital distributions according to the structural properties; and
c) a comparison module in which the two molecular orbital distributions according to structural properties, obtained by RDM in the molecular structure determining module, are compared using a profiling method.

12. The system of claim 11, wherein the two molecular orbitals are two electron states of one molecule, or identical or different electron states for two different molecules.

13. The system of claim 11, wherein the quantum chemistry calculation of the data input module is conducted through the distribution of an electron density function (ψ2) in each point determined in a molecular structure, the electron density function being a square of an orbital wave function (ψ).

14. The system of claim 11, wherein the quantum chemistry calculation of the data input module is conducted using single point energy calculation or geometry optimization calculation.

15. The system of claim 11, wherein the calculation of structural properties in the molecular structure-determining module is carried out using atomic coordinates of (x, y, z).

16. The system of claim 11, wherein the RDM (radially discrete mesh) calculation method of the molecular structure-determining module is carried out by creating meshes that are structured to expand at regular intervals in a radial direction, starting from a center of a molecule.

17. The system of claim 16, wherein the RDM (radially discrete mesh) calculation method of the molecular structure-determining module employs a total number (N) of 50 to 300 of RDM.

18. The system of claim 11, wherein the profiling method of the comparison module utilizes an RDM profile method by which comparison is made of molecular orbital distribution deviation in each RDM between two molecular orbitals.

19. The system of claim 11, wherein the profiling method of the comparison module employs TPD (total profile deviation) as represented by the following Equation 2:
$$TPD = \frac{1}{N} {\sum }_{k = 1}^{N} \vert Prof ( {A}_{k} ) - Prof ( {B}_{k} ) \vert \qquad ( Equation 2 )$$
(wherein Prof(Ak) and Prof(Bk) are molecular orbital values of respective RDM (k), and N is a total number of RDMs.)

20. The system of claim 19, wherein the profiling method of the comparison module utilizes MOD-Dscore as represented by the following Equation 3:
MOD-Dscore=1.0-TPD (Equation 3)
